(19) United States
(12) Patent Application Publication
(10) Pub. No.: US 2003/0196205 A1
(43) Pub. Date: Oct. 16, 2003

(54) Digital interactive AV playing and receiving system

(75) Inventors: Fu-Sheng Chiu, Taipei (TW); Chi-Yu Lai, Taipei (TW)

Correspondence Address: BACON & THOMAS, PLLC, 625 SLATERS LANE, FOURTH FLOOR, ALEXANDRIA, VA, 22314

(73) Assignee: ERA Digital Media Co., Ltd., Taipei (TW)

(21) Appl. No.: 10/162,920

(22) Filed: Jun. 6, 2002

(30) Foreign Application Priority Data
Apr. 11, 2002 (TW) 091107372

(51) Int. Cl. H04N 7/20; H04N 7/173; H04N 7/16

(52) U.S. Cl. 725/64; 725/63; 725/110; 725/141

(57) ABSTRACT

The present invention is to provide a digital interactive AV playing and receiving system including the Internet and a satellite both for interconnecting a digital program broadcaster and at least one LAN, wherein the system comprises the steps of converting an AV signal of at least one channel into a DVB-S signal based on a specific protocol by the broadcaster; uplinking the DVB-S signal to the satellite in order to broadcast the DVB-S signal to a predetermined range; receiving and converting the DVB-S signal into a multimedia stream by a satellite signal receiver; sending the multimedia stream to the LAN; and transmitting the multimedia stream to at least one client of the LAN for playing by means of a multimedia player.

### FIELD OF THE INVENTION

The present invention relates to a digital interactive audio-video (AV) playing and receiving system with improved characteristics.

### BACKGROUND OF THE INVENTION

Information technology have been under a rapid and a spectacular development leading to an increasing use of the Internet, electronic and telecommunication apparatus in our daily lives. Moreover, the increasing popularity of wide band network communication as well as the emerging of digital televisions (DTVs) has drawn much attention of entrepreneurs involving the telecommunication and information services. A digital television (DTVs) can receive a program via a satellite while receiving services provided by Web sites over the Internet.

DTVs are advantageous for providing a high quality picture and sound. In contrast, a conventional analog TV only has at most 525 scan lines, and its resolution is lower than DTVs. Worst of all, the images shown on the screen of the conventional analog TV tends to flash and the image signals received by the analog TV is susceptible to interference. Since the signals received by DTV are a series of digital values of “0” and “1”, the above disadvantages of screen flash, blurry, and noise interference as experienced in analog TVs will be eliminated in DTVs. In addition, the scan lines of DTV is increased from 525 up to 1,080, resulting in a clear, sharp, stable, and vivid image display. Also, a digital signal having six-channel Dolby surround effect as an improvement of two-channel stereo is made possible due to the signal compression characteristics thereof. Moreover, DTVs can provide a variety of services over the Internet, which are unobtainable by the analog TVs. Such services include weather forecast, news, traffic report, Video on Demand (VoD), online video games, and even shopping . . . etc. In view of the above, it is anticipated that the business related to DTVs is huge as the technology thereof becomes more ripe. Hence, many software companies have invested a lot of money and labor in research and development with respect to various technical fields of DTV.

But there are still problems yet to overcome in expanding the DTV market. In detail, a typical analog TV can only receive analog signal rather than Digital Video Broadcast for Satellite (DVB-S) signal sent via satellite. Therefore, if a user desires to watch TV having DVB-S signal sent via satellite or receive cable signals over the Internet for browsing, the user has to either buy a DTV to replace his/her analog TV or connect a DTV set-top box to the analog TV. Moreover, a DTV user must adapt himself/herself to the procedure of browsing implemented on DTV, since DTV is of a brand new hardware and system. Further, it is required to significantly change the typical procedure of browsing implemented thereon, since DTV has an associated browser provided by a digital program provider. This can bring much inconvenience to the TV user, and bear a great burden of cost on TV user in purchasing DTV and subscribing limited and expensive program resources.

Referring to FIG. 1, all files (such as multimedia stream including video and sound) in Web sites of the Internet 2 are stored in specific areas of a Web server 22. A capacity of uploading or downloading data between a Web server 22 and a browser installed on a computer 20 (hereinafter also referred as browser)is limited by both a cable installed between the Web server 22 and the browser 20 (note that other electronic components have little effect and thus can be omitted) and a maximum signal transmission speed of a data transmission device 24 coupled to the browser 20. Further, a bandwidth of the cable must be shared by all browser s 20 coupled to the Web server 22.

For example, it is assumed that the signal transmission speed in a cable is at most 100 Mbps (million bit per second) and there are 24 browsers 20 coupled to the Web server 22, each browser 20 can share only a signal transmission speed about 4.17 Mbps from the cable. The signal transmission speed between the browser 20 and the Web server 22 will be still maintained at 4.17 Mbps even if the maximum signal transmission speed of the browser 20 exceeds 4.17 Mbps.

However, most Web servers 22 in the Internet 2 only have a maximum signal transmission speed less than 100 Mbps due to the higher of signal transmission speed in Web site the higher of Web site installation cost. In a case of downloading files over the Internet, if a Web site is coupled to numerous browsers 20 then the signal transmission speed in each browser 20 is very low during the downloading. In a typical case the signal transmission speed is less than 1 Mbps or even less than 1 Kbps (Kilo bit per second). It is thus understood that the signal transmission speed between the browser 20 and the Web server 22 may vary as the number of browsers 20 changes. As a result, the signal transmission speed is not stable.

Typically, the play speed of a multimedia stream is about 200 to 500 kbps. If a Web server 22 cannot send the multimedia stream in a speed at a range between 200 to 500 kbps when a Microsoft Windows Media Player or other player plays the multimedia stream, the player must wait until to receive and accumulate a sufficient multimedia stream prior to play. Otherwise, no video or sound is played by the player. As a result, the images being played by the player may be interrupted and discontinuous, thus bringing inconvenience and causing interference to TV user.

Besides, since the distance between the Web server 22 and the browser 20 is relatively long (e.g., several kilometers), a number of network devices (e.g., bridges, routers, modems, etc.) have to be interconnected between the Web server 22 and the browser 20 to process the signals transmitted between the Web server 22 and the browser 20 for some specific purposes. This tends to produce errors in the signals, and cause an erroneous incomplete data being received by either the Web server 22 or the browser 20. For example, when the browser 20 reads a multimedia stream from the Web server 22, it is possible that a distorted picture (e.g., picture having mosaic blocks) or still picture occurs during the multimedia stream playing process of the player. To the worse, a condition of noise or no sound may occur. Hence, if DVB-S signal has been converted into multimedia stream prior to transmitting to the browser 20 from the Web server 22 over the Internet 2, then the quality of picture and sound cannot reach the same level as that of DTV.

Referring to FIG. 2, as a comparison to the structure shown in FIG. 1, in a LAN (Local Area Network) 1 there are provided with a switch (or hub) 10, a plurality of clients 14, and a server 16, wherein each client 14 and the server 16 are interconnected by a switch (or hub) 10 via a cable 12. This forms the LAN 1. Hence, the clients 14 and server 16 can transmit signal therebetween in the LAN 1. A signal transmission speed between two ports of the switch (or hub) 10 (e.g., between two clients 14 or between one client 14 and the server 16) is much faster than a signal transmission speed between the browser 20 and the Web server 22 over the Internet. Moreover, the number of errors (e.g., Internet Protocol (IP) packet lost) occurred in the LAN 1 during transmission is less than that over the Internet 2. In general, a signal transmission speed over the Internet 2 and a transmission quality thereof are better than that of the Internet under the reasons detailed below. A distance between any client 14 and the server 16 in the LAN 1 is relatively short (e.g., several hundred meters). Thus, the switch (or hub) 10 and the cable 12 are made sufficiently to carry out the signal transmission. For example, if a switch 10 has 24 ports each able to run in a maximum signal transmission speed of 10/100 Mbps, the maximum signal transmission speed of the switch 10 will be 100 Mbps×(24/2)=1,200 Mbps. That means a maximum network signal transmission speed at 1,200 Mbps can be achieved while transmitting signal from one port to the other or vice versa through the switch 10. In another example, if a hub 10 has 24 ports each able to run in a maximum signal transmission speed at 10/100 Mbps are shared by all coupled clients 14 and the server 16, the maximum signal transmission speed of the signal transmitted from one port to the other will be 100 Mbps/(24/2)=8.33 Mbps.

Moreover, signal does not tend to err at a transmission between any client 14 and the server 16 in the LAN 1 due to the short distance therebetween. Further, there is no need to install additional electronic devices between clients 14 and the server 16 for assuring a stability or accuracy of signal transmission in the LAN 1 and thus enabling the server 16 to transmit multimedia stream. In other words, clients 14 can receive an almost errorless multimedia stream and thus display a high quality multimedia stream even without the additional electronic devices.

In view of the above, it is understood that a signal transmission speed in the LAN 1 is faster than that in the Internet 2. Also, a more complete data can be obtained on a signal transmission from any client 14 to the server 16 in the LAN 1 or vice versa due to a more stable transmission process. As an end, a clear picture and a high quality sound can be obtained when the player plays the multimedia stream.

Thus, in a case that DVB-S signal is converted into multimedia stream which is in turn transmitted to each client 14 via the server 16 in the LAN 1. The multimedia stream received in the client 14 is further played therein. As a result, for the multimedia stream a time delay and noise interference occurred in the Internet 2 is greatly reduced. This in turn may increase a signal transmission speed of the multimedia stream without causing noise interference and obtain a clear picture and a high quality sound when the player plays the multimedia stream. Moreover, a TV user does not have to buy a DTV or a DTV set-top box for watching TV. Thus, it is desirable to provide means to enable a TV user to enjoy the high quality DTV by utilizing the existing hardware and software without changing the existing use and operation.

### SUMMARY OF THE INVENTION

It is therefore an object of the present invention to provide a digital interactive AV playing and receiving system including a digital program broadcaster, at least one LAN, the Internet, and a satellite both for interconnecting the digital program broadcaster and the LAN wherein the digital program broadcaster includes a media server and a Web server, the LAN includes at least one server and a plurality of clients and the Internet interconnects the server and the Web server for effecting a receiving or transmission of network signals, the system comprising the steps of converting an AV signal of at least one channel into a multimedia stream based on a specific protocol by the media server; sending the multimedia stream to a signal converter for converting into a DVB-S signal; uplinking the DVB-S signal to the satellite; broadcasting the DVB-S signal to a predetermined range by the satellite; receiving the DVB-S signal by a satellite signal receiver; converting the received DVB-S signal into a multimedia stream; sending the multimedia stream to the server in the LAN; and transmitting the multimedia stream to the clients for playing by means of a multimedia player.

In one aspect of the present invention, each channel of the satellite has a signal transmission speed of at least 1 Mbps. Also, a signal transmission speed of at least 8.33 Mbps is effected between each client and the server in the LAN. Thus, any signal is capable of transmitting with a speed no less than 1 Mbps between the digital program broadcaster and the LAN. Hence, in playing the multimedia stream by a player in each client a signal transmission speed of no less than 1 Mbps is effected. As a result, a clear picture and a high quality sound are obtained.

The above and other objects, features and advantages of the present invention will become apparent from the following detailed description taken with the accompanying drawings.

### BRIEF DESCRIPTION OF THE DRAWINGS

FIG. 1 presents schematically a conventional Internet structure;

FIG. 2 presents schematically a conventional LAN structure;

FIG. 3 presents schematically a system structure applicable for a preferred embodiment according to the invention;

FIG. 4 is a flow chart illustrating a process of uplinking AV signal to satellite by the digital program broadcaster according to the invention;

FIG. 5 is a flow chart illustrating a process of receiving DVB-S signal in the LAN according to the invention;

FIG. 6 is a flow chart illustrating a process of playing multimedia stream at the client according to the invention;

FIG. 7 presents schematically the connection between program provider and digital program broadcaster according to the invention;

FIG. 8 is a table of management database according to the invention; and

FIG. 9 is a flow chart illustrating a system management mechanism process according to the invention.

### DETAILED DESCRIPTION OF THE PREFERRED EMBODIMENTS

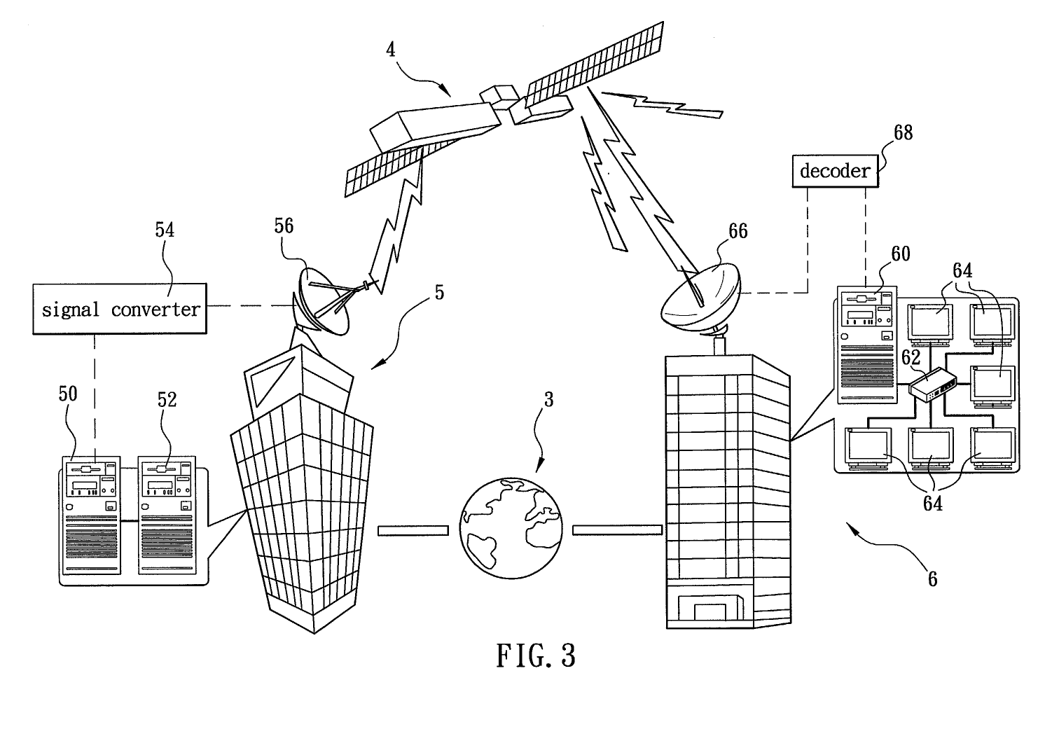

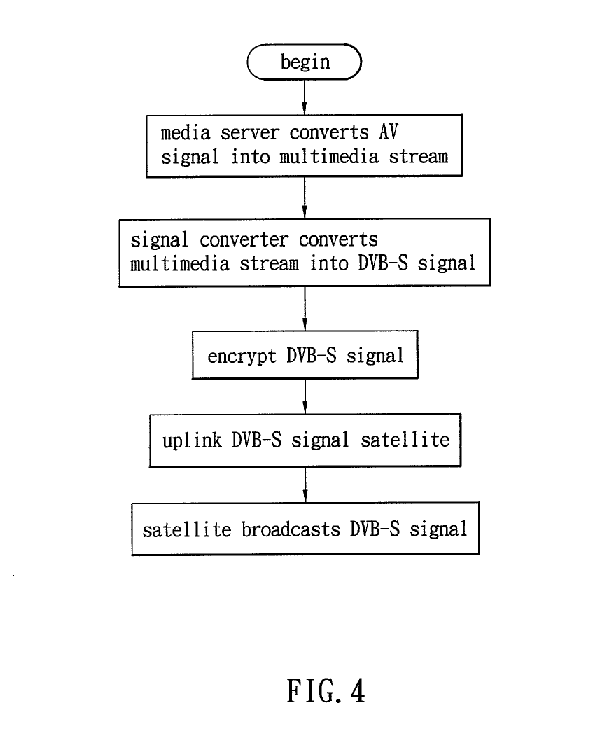

Referring to FIGS. 3 and 4, there is shown a digital interactive AV playing and receiving system in accordance with the invention comprising the Internet 3, a satellite 4, a digital program broadcaster 5, and a LAN 6 wherein the Internet 3 and the satellite 4 are provided for interconnecting the digital program broadcaster 5 and the LAN 6. The digital program broadcaster 5 comprises a media server 50 and a Web server 52. The media server 50 converts AV signal of at least one channel into a multimedia stream based on a specific protocol. The multimedia stream is then sent to a signal converter 54 for converting into a DVB-S signal. The DVB-S signal is in turn uplinked to the satellite 4. Finally, the satellite 4 may broadcast the DVB-S signal to a predetermined range.

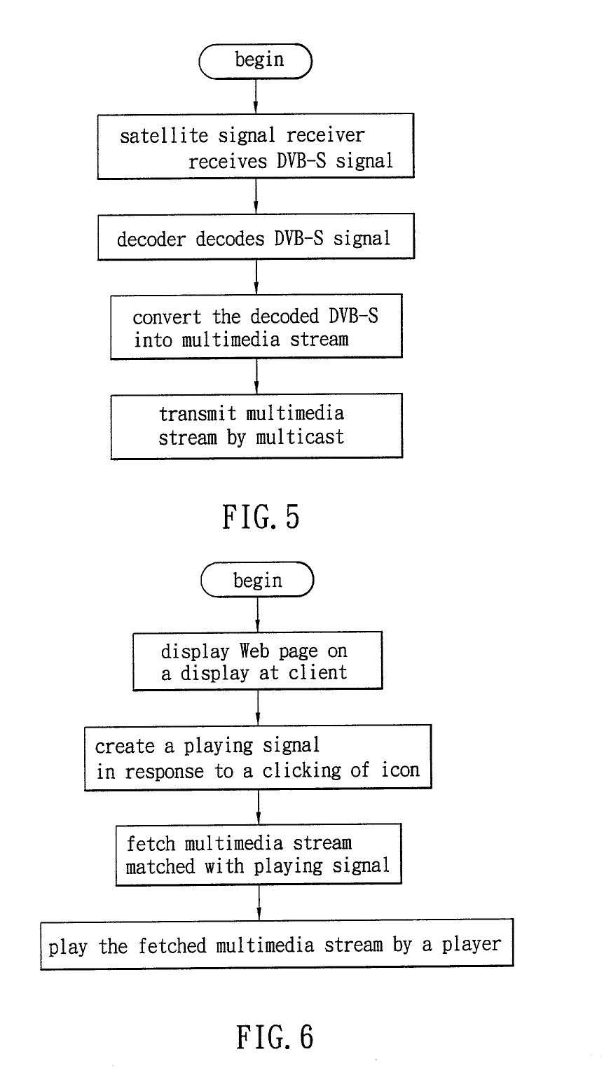

Referring to FIG. 5 in conjunction with FIG. 3, the LAN 6 comprises at least one server 60, at least one network interconnection device (e.g., switch or hub) 62, and a plurality of clients 64. The network interconnection device 62 serves as an agent between each of the clients 64 and the server 60 in the LAN 6. The Internet 3 interconnects the server 60 and the Web server 52 for effecting a receiving or transmission of network signals containing, for example, IP packets. A satellite signal receiver 66 serves to receive the DVB-S signal and converts the same into a multimedia stream which is in turn sent to the server 60. In the server 60, the multimedia stream is transmitted by means of multicast.

Referring to FIG. 6 in conjunction with FIG. 3, each client 64 is connected to the Web server 52 via the server 60. Thus, a display at the client 64 may display a Web page of the Web server 52. At least one icon representative of one channel is shown on the Web page. Hence, a playing signal is created in the Web server 52 in response to a clicking of one icon on the Web page. The playing signal is then sent to each client 64 for playing. Next, fetch the multimedia stream matched with the playing signal in the server 60 and play the fetched multimedia stream via a player. As a result, a picture and sound created by the multimedia stream is outputted.

Referring to FIGS. 3 and 4 specifically, in the invention an encryption is performed on the DVB-S signal based on one of a variety of encoding techniques prior to uplinking to the satellite 4. The satellite signal receiver 66 is coupled to a plurality of decoders (one is shown in FIG. 3) 68 wherein a unique decoding is effected in each decoder 68. Thus, in response to a receiving of the DVB-S signal in the satellite signal receiver 66, the decoders 68 may decode the DVB-S signal for converting it into a variety of multimedia streams which in turn are sent to the server 60.

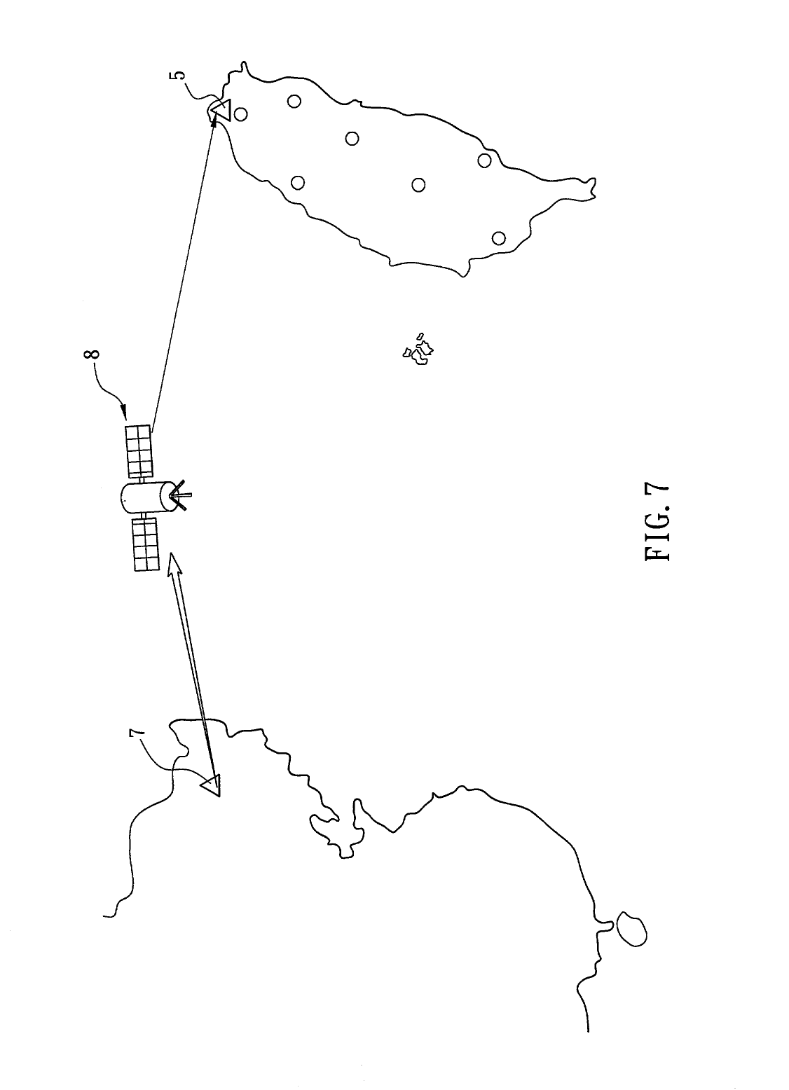

Referring to FIGS. 3 and 7 specifically, in the invention the channels provided by the digital program broadcaster 5 are supplied by at least one program provider 7 (located in a foreign country or remote area) wherein the program provider 7 may transmit AV signal of a channel to another satellite 8 by means of another DVB-S signal. Next, the digital program broadcaster 5 may receive another DVB-S signal via another satellite signal receiver 56. The received another DVB-S signal is further decoded as an AV signal. Then the media server 50 processes the AV signal. It is noted that the technique of uplinking AV signal to another satellite 8 is substantially the same as one implemented by a TV company in transmitting signals of picture and sound of a program to another place via a satellite. Thus, such well known technique will not be described in detail below since it is not the subject of the invention.

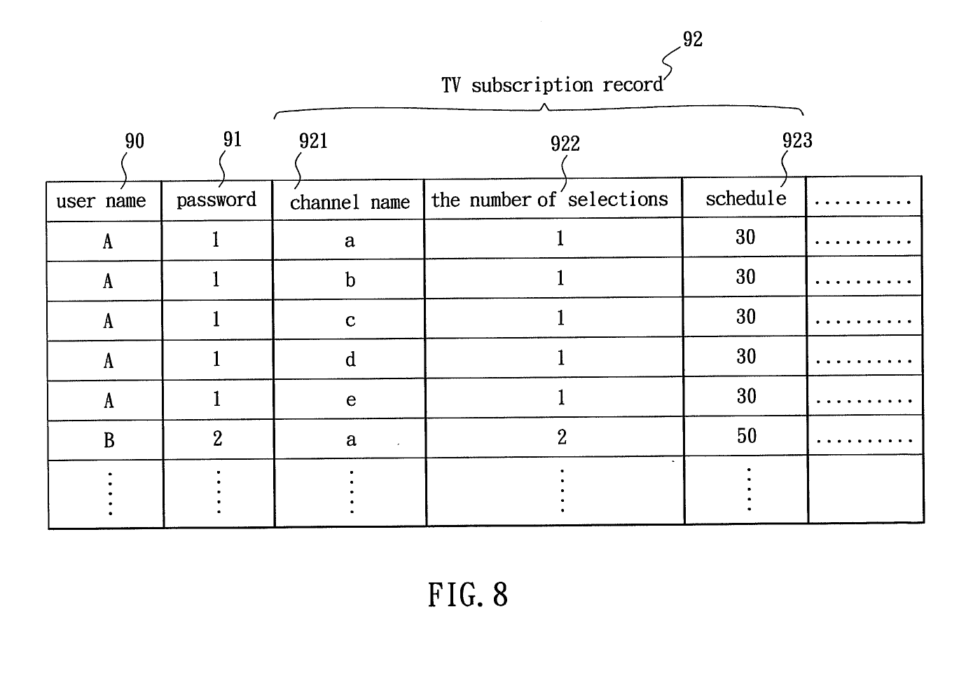

Referring to FIGS. 3, 8 and 9, in the invention there are provided a management database and a system management mechanism in the Web server 52. The management database comprises a plurality of fields of a user name 90, a password 91, and a TV subscription record 92. Fields of the TV subscription record 92 may be varied depending on requirements of the digital program broadcaster 5. In one preferred embodiment, they are comprised of a channel name 921, the number of selections 922, and a schedule 923. Such are employed as a basis for charging each client 64 by the digital program broadcaster 5 thereafter. For example, a client 64 may subscribe 5 channels each being selected once per month with a subscription time of each channel under 30 minutes. Thus, the digital program broadcaster 5 may charge the client 64 based on the number of subscriptions and/or a total subscription time as stipulated.

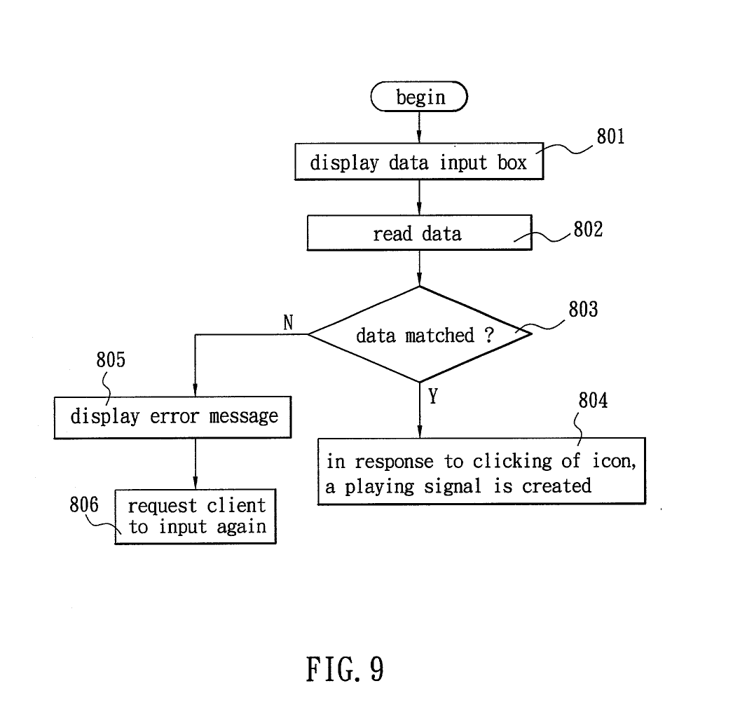

Referring to FIGS. 3 and 9 specifically, in response to a coupling of each client 64 and the Web server 52, each client 64 will perform the following steps by means of the system management mechanism:

In step 801, display a data input box on a Web page.

In step 802, the client 64 reads the user name 90 and the password 91 typed in the data input box.

In step 803, send the read data to the management database for determining whether the input user name 90 and password 91 are found in the management database. If found, the process goes to step 804. Otherwise, the process jumps to step 805.

In step 804, in response to a clicking of the media icon, the Web server 52 creates a playing signal corresponding to the selected media icon. Further, record the playing signal as a TV subscription record of the client 64. At the same time, the playing signal is sent to the client 64 so that the client 64 may fetch a corresponding multimedia stream stored in the server 60 based on the playing signal. Further, the fetched multimedia stream is played by a player. As a result, a picture and sound created by the multimedia stream is outputted.

In step 805, an input error message is displayed on the Web page.

In step 806, the client 64 is requested to input data again.

In the invention, the LAN 6 may be established in a building, a school, a network bar, a government organization, or an Internet Service Provider (ISP) as an intranet. Currently, each channel of a satellite has a signal transmission speed of at least 1 Mbps. Also, a signal transmission speed of at least 8.33 Mbps is effected between each client and the server in a LAN. Thus, any signal is capable of transmitting with a speed no less than 1 Mbps between the digital program broadcaster 5 and the LAN 6. Hence, in playing the multimedia stream by a player in each client 64 a signal transmission speed of no less than 1 Mbps is effected, and a clear picture and a high quality sound are obtained accordingly.

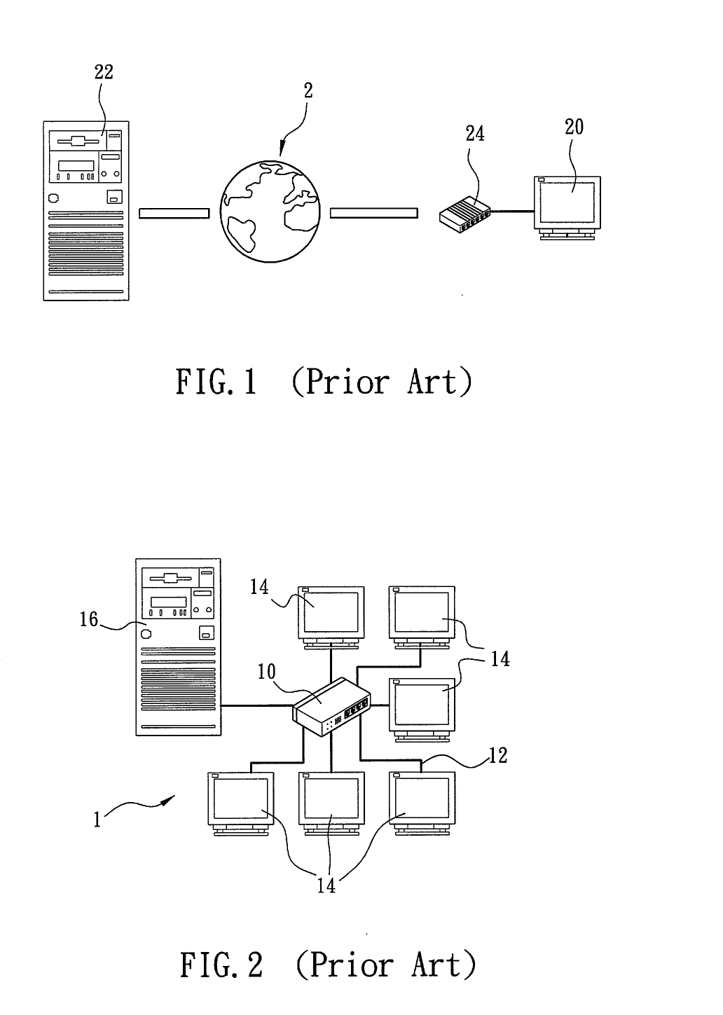

Moreover, as stated above, in the server of the LAN 6, the multimedia stream is transmitted by means of multicast. As such, when all clients 64 in the LAN 6 fetch the same multimedia stream, the player in each client 64 can transmit or receive in the same speed (e.g., 1 Mbps). This is the feature of multicast. In comparison with that shown in FIG. 1, it is found that the prior art drawbacks (i.e., in the Internet 2 the signal transmission speed of the Web server 22 becomes slow due to a sharing of all coupled browsers 20, resulting in an interruption and poor quality of received picture when the player is playing) are substantially eliminated.

In brief, a TV user neither has to buy additional computer products nor change the existing operating procedure. Instead, the TV user simply installs a satellite signal receiver coupled to an existing position of LAN for receiving a DTV program. This can significantly reduce a burden of cost on users. Further, the invention can solve the problems of inconvenience and interference while watching DTV as experienced by the prior art as well as reduce resource waste.

While the invention has been described by means of specific embodiments, numerous modifications and variations could be made thereto by those skilled in the art without departing from the scope and spirit of the invention set forth in the claims.

What is claimed is:

1. A digital interactive AV playing and receiving system including the Internet, and a satellite both for interconnecting a digital program broadcaster and at least one LAN, wherein the digital program broadcaster includes a media server and a Web server, the LAN includes at least one server and a plurality of clients and the Internet interconnects the server and the Web server for effecting a receiving or transmission of network signals, the system comprising the steps of:
converting an AV signal of at least one channel into a multimedia stream based on a specific protocol by the media server;
sending the multimedia stream to a signal converter for converting into a DVB-S signal;
uplinking the DVB-S signal to the satellite;
broadcasting the DVB-S signal to a predetermined range by the satellite;
receiving the DVB-S signal by a satellite signal receiver;
converting the received DVB-S signal into a multimedia stream;
sending the multimedia stream to the server in the LAN; and
transmitting the multimedia stream to the clients for playing by means of multicast.

2. The system of claim 1, wherein after transmitting the multimedia stream to the clients the system further comprises the steps of:
connecting each client to the Web server via the server;
displaying a Web page of the Web server on a display at the client wherein the Web page contains at least one icon representative of one channel;
creating a playing signal in the Web server in response to a clicking of one icon on the Web page;
sending the playing signal to each client for playing;
fetching the multimedia stream matched with the playing signal in the server based on the playing signal; and
playing the fetched multimedia stream via a player, thereby outputting a picture and sound created by the multimedia stream.

3. The system of claim 1, wherein the satellite signal receiver is coupled to a plurality of decoders each having a unique decoding, in response to the receiving of the DVB-S signal in the satellite signal receiver each decoder is operative to decode the DVB-S signal for converting it into a variety of multimedia streams which in turn are sent to the server.

4. The system of claim 1, wherein the program provider acts to transmit the AV signal of at least one channel to a second satellite by means of a second DVB-S signal, in response the digital program broadcaster acts to receive the second DVB-S signal via a second satellite signal receiver and the received second DVB-S signal is decoded as an AV signal which is in turn processed by the media server.

5. The system of claim 1, wherein the Web server comprises a system management mechanism and a management database having fields of a user name, a password, and a TV subscription record so that in cooperation with the system management mechanism each client is operative to perform the steps of:
displaying an data input box on the Web page;
reading the user name and the password typed in the data input box by the client;
sending the read data to the management database for determining whether the user name and the password are found in the management database; and
if the determination is positive in response to the clicking of the media icon, creating a playing signal corresponding to the media icon by the Web server and recording the playing signal as the TV subscription record of the client.
